(19) United States
(12) Patent Application Publication
(10) Pub. No.: US 2010/0134717 A1
(43) Pub. Date: Jun. 3, 2010

(54) LIQUID CRYSTAL DISPLAY DEVICE AND METHOD FOR MANUFACTURING THE SAME

(76) Inventors: Masaki Ikeda, Osaka (JP); Hisao Kawaguchi, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/524,474

(22) PCT Filed: Sep. 14, 2007
(86) PCT No.: PCT/JP2007/067939

§ 371 Date: Jul. 24, 2009

(30) Foreign Application Priority Data
Feb. 5, 2007 (JP) 2007-025178

(51) Int. Cl. G02F 1/13357; G02F 1/13

(52) U.S. Cl. 349/62; 349/187

(57) ABSTRACT

An LCD device includes an LCD panel which includes a first substrate provided on a display-light incident side, a second substrate provided on a display-light emitting side so as to face the first substrate through a liquid crystal material, and a color filter having strip-shaped color layers of a plurality of colors arranged in parallel. The LCD panel has a bright-spot-defect portion inside. The first substrate has a light-shielding portion formed in a region corresponding to the bright-spot-defect portion. The second substrate has a light-collecting portion formed in a region corresponding to the bright-spot-defect portion, for collecting incident light only in an extending direction of a corresponding color layer of the color filter.

### TECHNICAL FIELD

The present invention relates to a liquid crystal display (LCD) device and a manufacturing method thereof.

### BACKGROUND ART

LCD devices generally display characters and images on a display screen by switching a liquid crystal layer in each pixel portion of the display screen between a voltage applied state and a voltage non-applied state, and thus changing the orientation state of liquid crystal molecules in each pixel portion, and modulating the light-transmitting and light-scattering states of each pixel portion.

For example, in a normally black mode of the LCD devices in which black display is provided when no voltage is applied to the liquid crystal layer, short-circuits of wirings and electrodes, failures of TFTs (thin film transistors) as pixel switching devices, or the like may occur in each pixel portion. In this case, a voltage is kept applied to the liquid crystal layer of the pixel portion, and this pixel portion is displayed as a small bright spot, causing defective display. Moreover, when defective alignment is caused by a foreign particle or the like attached to a substrate surface, light leakage occurs, and is displayed as a small bright spot, causing defective display.

As a technique addressing such defective display, Patent Document 1, for example, discloses an LCD device in which a recess having a light-shielding material is formed at a position which optically overlaps a portion having a bright spot defect.

Patent Document 1: Japanese Published Patent Application No. 2005-189360

### DISCLOSURE OF THE INVENTION

### Problems to be Solved by the Invention

When a bright spot defect is repaired by the above technique, a light-shielding material provided to block leakage light is displayed as a black spot. The larger the black spot is, the more the black spot adversely affects the display state of a display portion.

In order to solve this problem, it is possible to form a light-collecting portion in a region corresponding to the position of the bright spot defect to reduce the area of the black, spot generated on a display screen by the light-shielding portion.

However, LCD devices have, for example, a color filter having pixels of a plurality of colors such as RGB, and the light-collecting portion collects light in the whole region around the light-collecting portion when collecting incident light. Thus, defective display occurs due to color mixture when an image is displayed on a display screen by the light emitted from the light-collecting portion.

### Means for Solving the Problems

The present invention was developed in view of the above problems, and it is an object of the present invention to provide an LCD device which suppresses defective display due to color mixture in a desirable manner, while reducing the area of a black spot on a display screen which is generated by repairing a bright spot defect, and a manufacturing method thereof.

An LCD device according to the present invention includes an LCD panel which includes a first substrate provided on a display-light incident side, a second substrate provided on a display-light emitting side so as to face the first substrate through a liquid crystal material, and a color filter formed on the first or second substrate, and having strip-shaped color layers of a plurality of colors arranged in parallel, and the LCD panel has a bright-spot-defect portion inside. The first substrate has a light-shielding portion formed in a region corresponding to the bright-spot-defect portion, and the second substrate has a light-collecting portion formed in a region corresponding to the bright-spot-defect portion, for collecting incident light only in an extending direction of a corresponding color layer of the color filter.

According to this structure, the light-shielding portion of the first substrate prevents display light, which is incident from the first substrate, from being applied to the bright-spot-defect portion to suppress light leakage to the display screen. Moreover, the light-collecting portion formed in the region corresponding to the bright-spot defect portion in the second substrate collects display light, which is incident from a region around the light-shielding portion of the first substrate, to reduce the area of a black spot formed on a display screen by the light-shielding portion of the first substrate. Moreover, since the light-collecting portion collects incident light only in the extending direction of the corresponding color layer of the color filter, color mixture due to the color layers of the plurality of colors can be suppressed. Thus, bright spot defects of the LCD panel can be suppressed in a desirable manner, and defective display resulting from color mixture can be suppressed in a desirable manner when an image is formed on the display screen by light emitted from the light-collecting portion.

### Effects of the Invention

As described above, an LCD device which suppresses defective display due to color mixture in a desirable manner while reducing the area of a black spot on a display screen which is generated by repairing a bright spot defect, and a manufacturing method thereof can be provided according to the present invention.

### BRIEF DESCRIPTION OF THE DRAWINGS

FIG. 1 is a cross-sectional view of an LCD device according to an embodiment of the present invention.

FIG. 2 is a perspective view of a cylindrical lens according to an embodiment of the present invention.

FIG. 3 is a diagram showing a positional relation among the cylindrical lens, a color filter, and a light-shielding portion according to an embodiment of the present invention.

FIG. 4 is a cross-sectional view of an LCD device having a cylindrical lens formed inside a glass substrate according to an embodiment of the present invention.

FIG. 5 is a cross-sectional view of an LCD panel in the step of locating a bright spot defect according to an embodiment of the present invention.

FIG. 6 is a cross-sectional view of the LCD panel in the step of fanning a light-shielding portion according to an embodiment of the present invention.

FIG. 7 is a cross-sectional view of the LCD panel in the step of forming a cylindrical lens according to an embodiment of the present invention.

FIG. 8 is a cross-sectional view of the LCD panel in the step of forming polarizing plates according to an embodiment of the present invention.

FIG. 9 is a cross-sectional view of an LCD device according to another embodiment of the present invention.

FIG. 10 is a perspective view of a concave lens of the LCD device according to another embodiment of the present invention.

FIG. 11 is a diagram showing a positional relation among the concave lens, a color filter, and a light-shielding portion according to another embodiment of the present invention.

FIG. 12 is a cross-sectional view of an LCD device having a concave lens formed inside a glass substrate according to another embodiment of the present invention.

FIG. 13 is a plan view of an image of a black spot according to a comparative example of the present invention.

FIG. 14 is a plan view of an image of a black spot according to an example of the present invention.

### DESCRIPTION OF CHARACTERS

10, 90 LCD device

11 TFT substrate

12 color filter substrate

13 liquid crystal layer

14 LCD panel

15 backlight

16 foreign particle

17 rear polarizing plate

18 bright-spot-defect portion

19 front polarizing plate

21, 22 glass substrate

30 light-shielding portion

31 tilted surface

40 color layer

42 concave surface

43 cylindrical lens

50 color filter

58 missing portion

60 recess

61, 65 light-shielding region

70 black spot

91 first side surface

92 second side surface

93 base end

94, 95 end

96 first tilted surface

97 second tilted surface

98 concave lens

100, 101 black spot

### BEST MODE FOR CARRYING OUT THE INVENTION

An LCD device and a manufacturing method thereof according to embodiments of the present invention will be described in detail below based on the accompanying drawings. Note that the present invention is not limited to the following embodiments.

### Embodiment

(Structure of an LCD device 10)

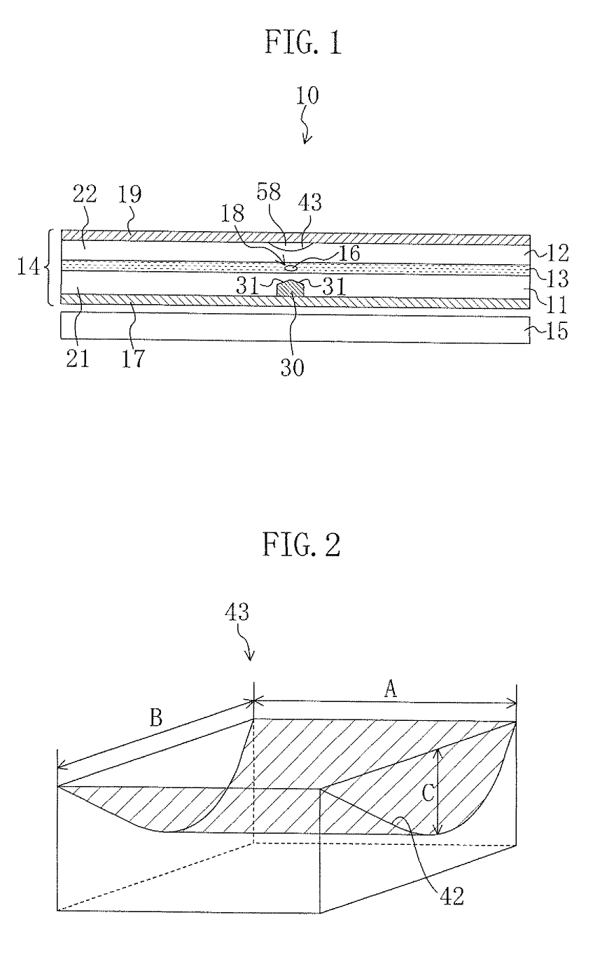

FIG. 1 is a cross-sectional view of the LCD device 10. The LCD device 10 is formed by an LCD panel 14, a backlight 15, and the like. The LCD panel 14 includes a TFT substrate 11 (first substrate) and a color filter substrate 12 (second substrate) which face each other, a liquid crystal layer 13 provided therebetween, not-shown columnar spacers positioned between the opposing substrates, and the like.

A bright spot defect which is generated by a foreign particle 16 contained in the liquid crystal layer 13 is herein described as an example of a bright spot defect in the embodiment of the present invention. However, the present invention is not limited to this, and the bright spot defect may be a bright spot defect such as an alignment defect caused by a defective alignment film or the like.

The TFT substrate 11 is formed by a glass substrate 21, and not-shown components formed on the glass substrate 21, including TFT elements such as gate electrodes, source electrodes, and drain electrodes, a transparent insulating layer, pixel electrodes, and an alignment film. A rear polarizing plate 17 is formed on an outer surface of the TFT substrate 11.

The glass substrate 21 of the TFT substrate 11 has a light-shielding portion 30 in a region corresponding to a foreign-particle position (bright-spot-defect portion 18) in the liquid crystal layer 13.

The light-shielding portion 30 is formed so as to cover the bright-spot-defect portion 18 when the glass substrate 21 is viewed in plan, so that incident light (display light) from the backlight 15 positioned on the back side does not reach the bright-spot-defect portion 18. The light-shielding portion 30 is fowled in a columnar shape which extends from an outer surface of the glass substrate 21 in a thickness direction. The light-shielding portion 30 is formed so that the diameter thereof gradually decreases from a predetermined thickness position in the glass substrate 21 to the top of the light-shielding portion 30. In other words, the light-shielding portion 30 has tilted surfaces 31 which are tapered from the display-light incident side of the glass substrate 21, i.e., the side of the glass substrate 21 on which the display light is incident, toward the inside of the LCD panel 14 so that the diameter of the light-shielding portion 30 decreases. The light-shielding portion 30 is made of a resin having a light-shielding property, such as a black resin.

Note that the light-shielding portion 30 is not limited to the above shape, but may have any shape which covers the bright-spot-defect portion 18 in the liquid crystal layer 13. The light-shielding portion 30 need not necessarily be formed on the outer surface of the glass substrate 21. For example, the light-shielding portion 30 may be formed so as to be completely embedded inside the glass substrate 21.

In the color filter substrate 12, a color filter 50 having strip-shaped color layers 40 of three primary colors of red (R), green (G), and blue (B) arranged in parallel is formed on a glass substrate 22, and these color layers 40 form a display portion. In addition to the combination of RGB, complementary colors such as cyan, magenta, and yellow may be used as the color layers 40. A not-shown counter electrode and a not-shown alignment film are formed on the color layers 40. A black matrix is provided along the outer periphery of each color layer 40 as a frame to obtain high contrast. A front polarizing plate 19 is formed on an outer surface of the color filter substrate 12.

The glass substrate 22 of the color filter substrate 12 has a light-collecting portion formed in a region corresponding to the foreign-particle position (bright-spot-defect portion 18) in the liquid crystal layer 13.

The light-collecting portion is formed by a cylindrical lens (concave lens) 43 formed on a surface of the color filter substrate 12.

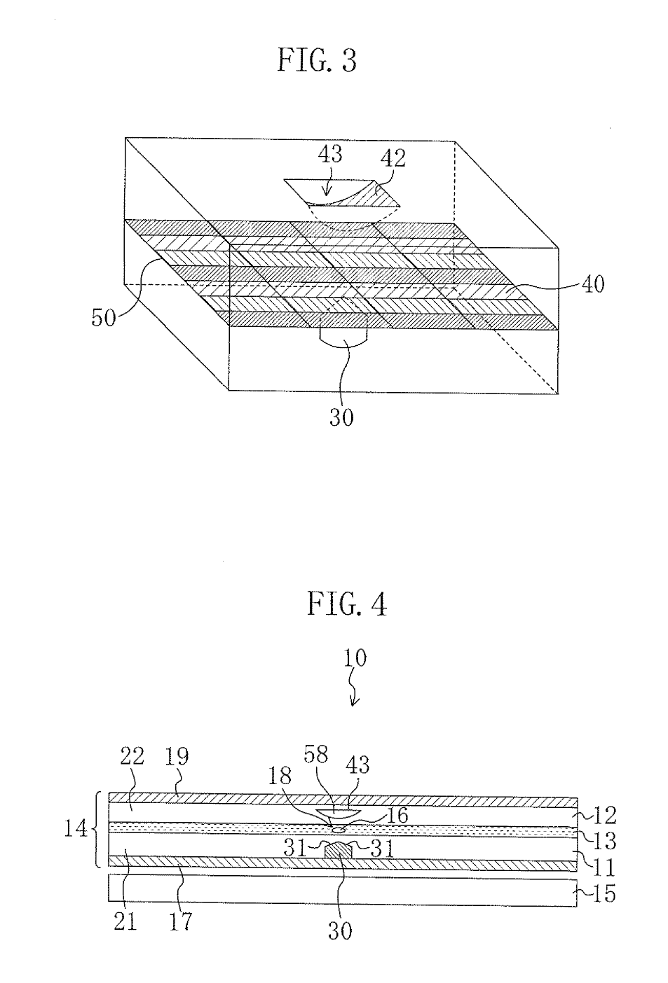

As shown in FIG. 2, the cylindrical lens 43 has, for example, a semicylindrical surface of the following size as a concave surface 42: width A: about 0.5 mm; length B: about 0.5 mm; and largest depth C of the concave surface: about 0.138 mm. As shown in FIG. 3 which shows a positional relation among the cylindrical lens 43, the color filter 50, and the light-shielding portion 30, the concave surface (semicylindrical surface) 42 having a curvature is formed only in one direction (extending direction of a corresponding color layer 40 of the color filter 50), and the cylindrical lane 43 is provided so that the concave surface 42 faces the display-light emitting side, i.e., the side from which the display light from the backlight 15 is emitted, and so that the bright-spot-defect portion 18 is positioned in the middle of the concave surface 42. In other words, the cylindrical lens 43 is provided on the surface of the color filter substrate 12 so that the width (A) direction shown in FIG. 2 extends perpendicularly to the extending direction of the corresponding color layer 40 of the color filter 50, and the length direction extends parallel to the extending direction of the corresponding color layer 40 of the color filter 50, and so that the concave surface 42 is recessed toward the display-light incident side.

The cylindrical lens 43 is covered by the front polarizing plate 19 formed on the surface of the display-light emitting side of the color filter substrate 12.

A missing portion 58 formed between the front polarizing plate 19 and the cylindrical lens 43 is filled with air.

The missing portion 58 need not necessarily be filled with air. For example, the missing portion 58 may be filled with an inert gas such as nitrogen, other gas, a liquid, or a solid such as aerogel.

The missing portion 58 may be filled with nothing, that is, may be a vacuum.

Note that the cylindrical lens 43 need not necessarily be formed on the outer surface of the glass substrate 22. For example, as shown in FIG. 4, the cylindrical lens 43 may be formed so as to be completely embedded inside the glass substrate 22.

There may be a plurality of bright-spot-defect portions 18. In this case, the light-shielding portion 30 and the cylindrical lens 43 are respectively formed in the glass substrates 21, 22 at each position corresponding to the bright-spot-defect portions 43.

The backlight 15 is positioned on the TFT substrate 11 side of the LCD panel 14. The backlight 15 has a light source, a light guide plate for receiving light emitted from the light source, and emitting the light toward the LCD panel 14 by transmitting the light therethrough, and a reflector for reflecting the light emitted from a back surface of the light guide plate toward the light guide plate (none of these components are shown in the figure),

(Manufacturing Method of the LCD Device 10)

A manufacturing method of the LCD device 10 according to the present embodiment will be described in detail below with reference to the drawings.

First, a portion having light leakage is located by emitting light from the backlight 15 to the TFT substrate 11 side of the LCD panel 14 having a foreign particle 16 contained in the liquid crystal layer 13 as shown in FIG. 5.

Then, a bright-spot-defect portion 18 is identified by performing marking on a region of the outer surface of the TFT substrate 11 which corresponds to the position of the light leakage.

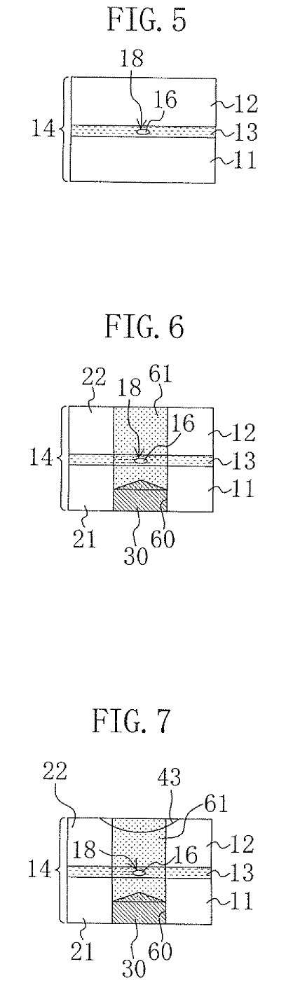

Then, as shown in FIG. 6, a recess 60 is formed in a region corresponding to the bright-spot-defect portion 18 in a surface located on the opposite side to the liquid crystal layer 13 side of the TFT substrate 11 of the LCD panel 14. In other words, the recess 60 is formed at a position which covers the bright-spot-defect portion 18, so that incident light (display light) from the backlight 15 provided on the back side does not reach the bright-spot-defect portion 18.

The recess 60 is formed by a boring process by pressing a tip of a pen point, as pen-point means having a diamond head mounted thereon, against the surface of the glass substrate 21. It is preferable to use a pen point having a pointed tip.

Then, the light-shielding portion 30 is formed by supplying a black resin into the recess 60 as a light-shielding material, and curing the resin by heating it, leaving it at room temperature, or the like. When display light is emitted from the backlight 15 to the back side of the TFT substrate 11 having the light-shielding portion 30 formed therein, the light-shielding portion 30 blocks the incident light, and a light-shielding region 61 appears in the LCD panel 14 as shown in FIG. 6.

Then, as shown in FIG. 7, the cylindrical lens 43 is formed in the glass substrate 22 of the color filter substrate 12 in a region corresponding to the bright-spot-defect portion 18 in the liquid crystal layer 13.

The cylindrical lens 43 is formed by applying femtosecond pulsed laser light to the surface of the color filter substrate 12 by using, for example, a titanium, sapphire laser.

As in the present embodiment, a femtosecond pulsed laser having a pulse time width shorter than a picosecond provides a non-thermal process in which heating of lattice ions is started after application of laser light through a non-equilibrium state (two-temperature distribution) where the electron temperature is sufficiently higher than the lattice ion temperature. In such a non-thermal process, the thermal influence of ablation can be reduced and thus, processing in a nanometer size range equal to or less than the wavelength can be implemented by multi-photon absorption.

Femtosecond pulsed laser light is applied to the surface of the color filter substrate 12 with a pulse time width of, for example, 100 femtoseconds or less, preferably 1 femtosecond or less. Although the femtosecond pulsed laser light may have any wavelength, especially femtosecond pulsed laser light having a medium wavelength (700 to 900 nm, preferably 780 nm, or 260 nm which causes a linear absorption process) enables the cylindrical lens 43 to be formed either on the surface or inside of the glass substrate 22.

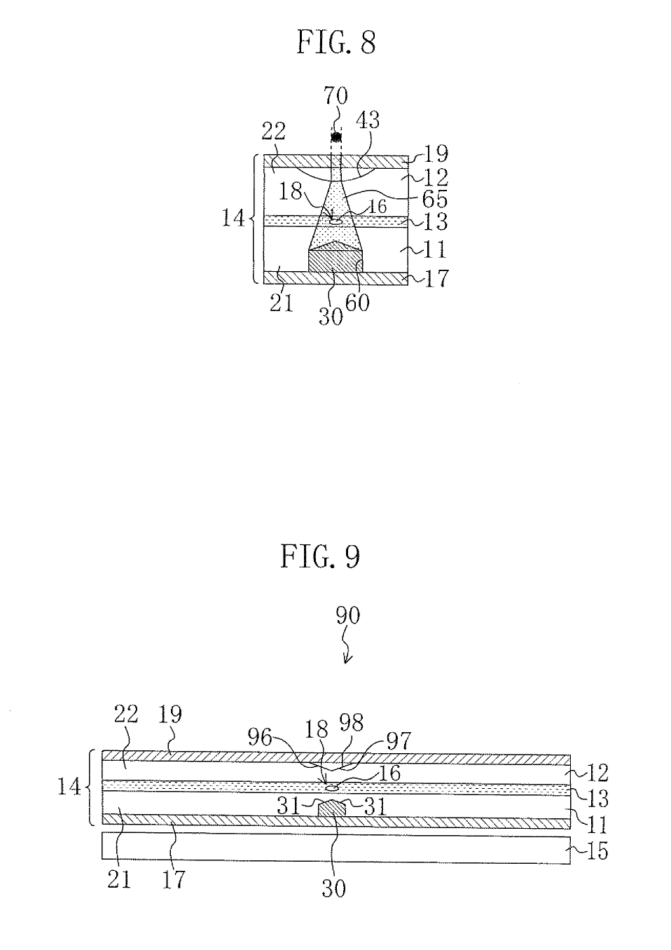

Then, as shown in FIG. 8, the rear polarizing plate 17 and the front polarizing plate 19 are respectively formed on the surface of the TFT substrate 11 and the surface of the color filter substrate 12 to fabricate the LCD panel 14, and the backlight 15 is provided to manufacture the LCD device 10.

Note that, in the present embodiment, the femtosecond pulsed laser was used to form the cylindrical lens 43. However, the present invention is not limited to this, and other lasers such as a nanosecond pulsed laser and a picosecond pulsed laser may be used. Alternatively, the cylindrical lens 43 may be formed by, for example, cutting with a drill.

[Functions and Effects of the LCD Device 10]

Functions and effects will be described below.

The LCD device 10 of the present embodiment includes the LCD panel 14 which includes the TFT substrate 11 provided on the display-light incident side, the color filter substrate 12 provided on the display-light emitting side so as to face the TFT substrate 11 through the liquid crystal layer 13, and the color filter 50 in which the strip-shaped color layers 40 of a plurality of colors are arranged in parallel, and the LCD panel 14 has the bright-spot-defect portion 18 inside. The TFT substrate 11 has the light-shielding portion 30 formed in a region corresponding to the bright-spot-defect portion 18, and the color filter substrate 12 has the cylindrical lens 43 formed in a region corresponding to the bright-spot-defect portion 18, for collecting incident light only in the extending direction of the corresponding color layer 40 of the color filter 50.

In this structure, the light-shielding portion 30 blocks incident light from the backlight 15 so that the bright-spot-defect portion 18 in the liquid crystal layer 13 is included in the light-shielding region. Light leakage on a display screen is prevented in this manner.

When display light of the backlight 15 is incident from the TFT substrate 11 side, the cylindrical lens 43 of the LCD panel 14 refracts the incident light so as to collect the incident light only in one direction of the cylindrical lens 43 (the extending direction of the corresponding color layer 40 of the color filter 50), thereby foaming a light-shielding region 65 as shown in FIG. 8. At this time, an image of the light-shielding region 65 is formed with its size reduced toward the middle in the extending direction of the parallel-arranged strip-shaped color layers 40 of the three primary colors of red (R), green (G), and blue (B) of the color filter 50. Moreover, the image of the light-shielding region 65 is formed with its original size, that is, without reduction in size, in a direction perpendicular to the extending direction of the color layers 40. Thus, the area of a black spot 70 formed on the display screen is reduced, while suppressing color mixture by gathering the image of the light-shielding region 65 (black spot 70) in the extending direction of the corresponding color layer 40 of the color filter 50.

### Another Embodiment

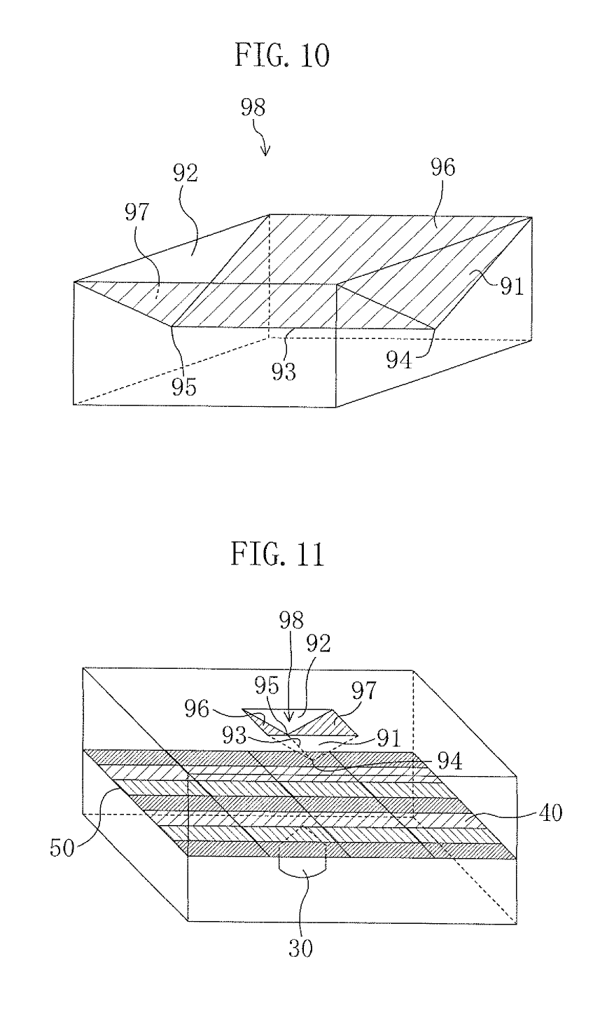

FIGS. 9 through 11 show an LCD device 90 according to another embodiment of the present invention. The LCD device 90 is different from the above LCD device 10 only in the shape of the light-collecting portion. In other words, the light-collecting portion of the LCD device 90 is not formed by the cylindrical lens 43, but by a concave lens 98. The concave lens 98 has a base end 93 formed so as to extend perpendicularly to the extending direction of the corresponding color layer 40 of the color filter 50. The concave lens 98 further has a first tilted surface 96 and a second tilted surface 97, which are formed so as to extend away from each other from the base end 93 toward the display-light emitting side, and a first side surface 91 and a second side surface 92, which are formed so as to extend vertically from both ends 94, 95 of the base end 93 toward the display-light emitting side, respectively.

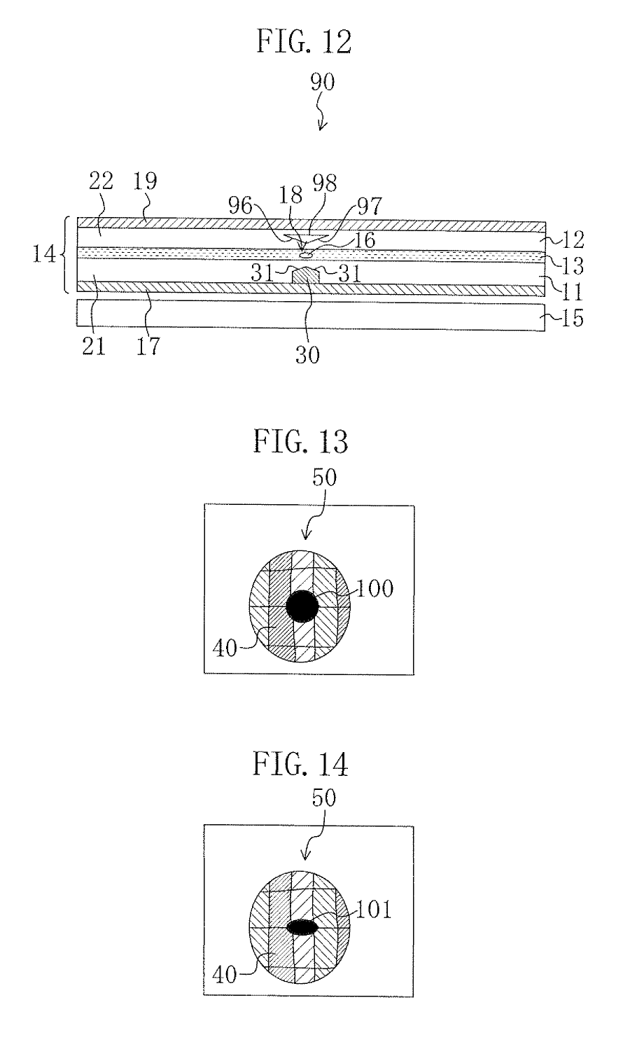

Note that, as shown in FIG. 12, the concave lens 98 of the LCD device 90 may be formed so as to be completely embedded inside the glass substrate 22.

[Functions and Effects of the LCD Device 90]

In the LCD device 90, the light-shielding portion 30 blocks incident light from the backlight 15 so that the bright-spot-defect portion 18 in the liquid crystal layer 13 is included in the light-shielding region. Light leakage on a display screen is prevented in this manner.

When display light of the backlight 15 is incident from the TFT substrate 11 side, the concave lens 98 refracts the incident light so as to collect the incident light only in one direction of the concave lens 98 (the extending direction of the corresponding color layer 40 of the color filter 50). At this time, an image of the light-shielding region 65 is formed with its size reduced toward the middle in the extending direction of the parallel-arranged strip-shaped color layers 40 of the three primary colors of red (R), green (G), and blue (B) of the color filter 50, due to refraction by the first tilted surface 96 and the second tilted surface 97 of the concave lens 98. Moreover, the image of the light-shielding region 65 is formed with its original size, that is, without reduction in size, in a direction perpendicular to the extending direction of the color layers 40, because the first side surface 91 and the second side surface 92 of the concave lens 98 are formed so as to extend vertically from both ends 94, 95 of the base end 93 toward the display-light emitting side, respectively. Thus, the area of a black spot 70 formed on the display screen is reduced, while suppressing color mixture by gathering the image of the light-shielding region 65 (black spot 70) in the extending direction of the corresponding color layer 40 of the color filter 50.

Although some examples were shown in the embodiments, the LCD device according to the present invention includes an LCD panel which includes a first substrate provided on a display-light incident side, a second substrate provided on a display-light emitting side so as to face the first substrate through a liquid crystal material, and a color filter formed on the first or second substrate, and having strip-shaped color layers of a plurality of colors arranged in parallel, and the LCD panel has a bright-spot-defect portion inside. The first substrate has a light-shielding portion formed in a region corresponding to the bright-spot-defect portion, and the second substrate has a light-collecting portion formed in a region corresponding to the bright-spot-defect portion, for collecting incident light only in an extending direction of a corresponding color layer of the color filter.

According to this structure, the light-shielding portion of the first substrate prevents display light, which is incident from the first substrate, from being applied to the bright-spot-defect portion to suppress light leakage to the display screen. Moreover, the light-collecting portion formed in the region corresponding to the bright-spot defect portion in the second substrate collects display light, which is incident from a region around the light-shielding portion of the first substrate, to reduce the area of a black spot formed on a display screen by the light-shielding portion of the first substrate. Moreover, since the light-collecting portion collects incident light only in the extending direction of the corresponding color layer of the color filter, color mixture due to the color layers of the plurality of colors can be suppressed. Thus, bright spot defects of the LCD panel can be suppressed in a desirable manner, and defective display resulting from color mixture can be suppressed in a desirable manner when an image is formed on the display screen by light emitted from the light-collecting portion.

Moreover, in the LCD device of the present invention, the light-collecting portion may be formed by a concave lens provided so that a concave surface thereof faces the display-light emitting side.

According to this structure, since the light-collecting portion is formed by the concave lens provided so that the concave surface thereof faces the display-light emitting side, an image of a black spot is gathered toward the middle of the bright spot when displayed on the display screen, whereby the area of the black spot can be reduced in a desirable manner.

Moreover, in the LCD device of the present invention, the concave lens may be formed by a cylindrical lens having a curvature only in the extending direction of the corresponding color layer of the color filter.

According to this structure, since the concave lens is formed by the cylindrical lens having a curvature only in the extending direction of the corresponding color layer of the color filter, the concave surface of the concave lens can effectively collect incident light only in the extending direction of the color layer.

Moreover, in the LCD device of the present invention, the concave lens may have a base end formed so as to extend perpendicularly to the extending direction of the corresponding color layer of the color filter, first and second tilted surfaces formed so as to extend away from each other from the base end toward the display-light emitting side, and first and second side surfaces formed so as to extend vertically from both ends of the base end toward the display-light emitting side, respectively.

According to this structure, since the concave lens has the base end formed so as to extend perpendicularly to the extending direction of the corresponding color layer of the color filter, the first and second tilted surfaces formed so as to extend away from each other from the base end toward the display-light emitting side, and the first and second side surfaces formed so as to extend vertically from both ends of the base end toward the display-light emitting side, respectively, the first and second tilted surfaces of the concave lens can collect incident light only in the extending direction of the color layer.

Moreover, in the LCD device of the present invention, the concave lens may be formed on a surface of the display-light emitting side of the second substrate.

According to this structure, since the concave lens is formed on the surface of the display-light emitting side of the second substrate, the degree of freedom in formation of the concave lens is increased, which improves the efficiency of forming the concave lens.

Moreover, in the LCD device of the present invention, the concave lens may be formed inside the second substrate.

According to this structure, since the concave lens is formed inside the second substrate, the concave lens can be provided without producing concaves and convexes on the surface of the second substrate. Thus, defective display resulting from the concaves and convexes on the substrate surface can be suppressed.

A method for manufacturing an LCD device according to the present invention includes the steps of: preparing an LCD panel including a first substrate provided on a display-light incident side, a second substrate provided on a display-light emitting side so as to face the first substrate through a liquid crystal material, and a color filter formed on the first or second substrate, and having strip-shaped color layers of a plurality of colors arranged in parallel, the LCD panel having a bright-spot defect portion inside; forming a light-shielding portion in a region corresponding to the bright-spot-defect portion in the first substrate; and forming a light-collecting portion in a region corresponding to the bright-spot-defect portion in the second substrate, for collecting incident light only in an extending direction of a corresponding color layer of the color filter.

According to this structure, the light-shielding portion of the first substrate prevents display light, which is incident from the first substrate, from being applied to the bright-spot-defect portion to suppress light leakage to the display screen. Moreover, the light-collecting portion formed in the region corresponding to the bright-spot defect portion in the second substrate collects display light, which is incident from a region around the light-shielding portion of the first substrate, to reduce the area of a black spot formed on a display screen by the light-shielding portion of the first substrate. Moreover, since the light-collecting portion collects incident light only in the extending direction of the corresponding color layer of the color filter, color mixture due to the color layers of the plurality of colors can be suppressed. Thus, bright spot defects of the LCD panel can be suppressed in a desirable manner, and defective display resulting from color mixture can be suppressed in a desirable manner when an image is formed on the display screen by light emitted from the light-collecting portion.

Moreover, in the method of the present invention, the light-collecting portion may be a concave lens formed so that a concave surface thereof faces the display-light emitting side.

According to this structure, since the light-collecting portion is the concave lens formed so that the concave surface thereof faces the display-light emitting side, an image of a black spot is gathered toward the middle of the bright spot when displayed on the display screen, whereby the area of the black spot can be reduced in a desirable manner.

Moreover, in the method of the present invention, the concave lens may be formed by applying femtosecond pulsed laser light to the second substrate.

According to this structure, since the concave lens is formed by applying femtosecond pulsed laser light to the second substrate, the concave lens can be formed by a non-thermal process which uses a short pulse width and which does not generate heat in the substrate, as opposed to the case of applying nanosecond pulsed laser light, picosecond pulsed laser light, or the like. This can suppress, for example, formation of white turbidity in a transparent substrate during processing of the substrate, and can also suppress generation of cracks at the substrate surface. Moreover, this can suppress reduction in performance of the device due to the thermal influence in a desirable manner. Since the femtosecond pulsed laser light can easily cause multi-photon absorption, substrates of various materials can be processed in addition to a glass substrate, thereby increasing the degree of freedom in manufacturing.

Preferably, the femtosecond pulsed laser light has a pulse time width of 100 femtoseconds or less, and more preferably 1 femtosecond or less.

According to this structure, the above advantages of the femtosecond pulsed laser light can be obtained in a more desirable manner.

Moreover, in the method of the present invention, the concave lens may be formed on a surface of the display-light emitting side of the second substrate.

According to this structure, since the concave lens is formed on the surface of the display-light emitting side of the second substrate, the degree of freedom in formation of the concave lens is increased, which improves the efficiency of forming the concave lens.

Moreover, in the method of the present invention, the concave lens may be formed inside the second substrate.

According to this structure, since the concave lens is formed inside the second substrate, the concave lens can be provided without producing concaves and convexes on the surface of the second substrate. Thus, defective display resulting from the concaves and convexes on the substrate surface can be suppressed.

### Examples

(Evaluation Test)

(Fabrication of Evaluation LCD Panels)

An evaluation test for confirming reduction in area of a bright spot defect in an LCD panel was carried out by using an LCD panel having a structure similar to that of the LCD panel 14 having the cylindrical lens 43 according to the above embodiment.

In a manufacturing process of the LCD panel, the concave surface of the cylindrical lens formed in the color filter substrate had a width A of 0.58 mm, a length B of 0.5 mm, and a maximum depth C of 0.138 mm. The curvature of the concave surface of the cylindrical lens was formed so that a light-receiving angle becomes 520 . The light-shielding portion of the TFT substrate was formed so as to have a substantially square area of 0.25×0.25 mm when the TFT substrate was viewed in plan. The LCD panel fabricated in this manner was used as an example.

In addition to this LCD panel, an LCD panel having a light-shielding portion similar to that of the above example in a TFT substrate, and having no cylindrical lens in a color filter substrate was also fabricated as a comparative example.

(Evaluation Result)

Display light was emitted from the backlight to the LCD panels of the example and the comparative example which were fabricated as described above. As shown in FIG. 13, a black spot 100 formed on the display screen of the LCD panel of the comparative example had a width similar to that of the light-shielding portion. On the other hand, as shown in FIG. 14, a black spot 101 formed on the display screen of the LCD panel of the example had its size reduced toward the middle of the concave lens only in one direction.

In other words, the image of the light-shielding region was reduced in size in the extending direction of the parallel-arranged strip-shaped color layers 40 of red (R), green (G), and blue (B) of the color filter 50, and the black spot 101 generated had a width of 0.1 mm in this direction. The image of the light-shielding region was not reduced in size in the direction perpendicular to the extending direction of the color layers, and the black spot 101 generated had a width of 0.25 mm in this direction, i.e., the same width as that of the light-shielding region.

In this case, no color mixture occurred near the black spot 101 formed on the display screen.

### INDUSTRIAL APPLICABILITY

As described above, the present invention is useful for an LCD device and a manufacturing method thereof.

1. A liquid crystal display device, comprising:
a liquid crystal display panel including a first substrate provided on a display-light incident side, a second substrate provided on a display-light emitting side so as to face the first substrate through a liquid crystal material, and a color filter formed on the first or second substrate, and having strip-shaped color layers of a plurality of colors arranged in parallel, the liquid crystal display panel having a bright-spot-defect portion inside, wherein
the first substrate has a light-shielding portion formed in a region corresponding to the bright-spot-defect portion, and
the second substrate has a light-collecting portion formed in a region corresponding to the bright-spot-defect portion, for collecting incident light only in an extending direction of a corresponding color layer of the color filter.

2. The liquid crystal display device of claim 1, wherein
the light-collecting portion is formed by a concave lens provided so that a concave surface thereof faces the display-light emitting side.

3. The liquid crystal display device of claim 2, wherein
the concave lens is formed by a cylindrical lens having a curvature only in the extending direction of the corresponding color layer of the color filter.

4. The liquid crystal display device of claim 2, wherein
the concave lens has a base end formed so as to extend perpendicularly to the extending direction of the corresponding color layer of the color filter, first and second tilted surfaces formed so as to extend away from each other from the base end toward the display-light emitting side, and first and second side surfaces formed so as to extend vertically from both ends of the base end toward the display-light emitting side, respectively.

5. The liquid crystal display device of claim 2, wherein
the concave lens is formed on a surface of the display-light emitting side of the second substrate.

6. The liquid crystal display device of claim 2, wherein
the concave lens is formed inside the second substrate.

7. A method for manufacturing a liquid crystal display device, comprising the steps of:
preparing a liquid crystal display panel including a first substrate provided on a display-light incident side, a second substrate provided on a display-light emitting side so as to face the first substrate through a liquid crystal material, and a color filter formed on the first or second substrate, and having strip-shaped color layers of a plurality of colors arranged in parallel, the liquid crystal display panel having a bright-spot defect portion inside;
forming a light-shielding portion in a region corresponding to the bright-spot-defect portion in the first substrate; and
forming a light-collecting portion in a region corresponding to the bright-spot-defect portion in the second substrate, for collecting incident light only in an extending direction of a corresponding color layer of the color filter.

8. The method of claim 7, wherein
the light-collecting portion is a concave lens formed so that a concave surface thereof faces the display-light emitting side.

9. The method of claim 8, wherein
the concave lens is formed by applying femtosecond pulsed laser light to the second substrate.

10. The method of claim 9, wherein
the femtosecond pulsed laser light has a pulse time width of 100 femtoseconds or less.

11. The method of claim 9, wherein
the femtosecond pulsed laser light has a pulse time width of 1 femtosecond or less.

12. The method of claim 8, wherein
the concave lens is formed on a surface of the display-light emitting side of the second substrate.

13. The method of claim 8, wherein
the concave lens is formed inside the second substrate.
